(19) United States
(12) Patent Application Publication
(10) Pub. No.: US 2017/0268503 A1
(43) Pub. Date: Sep. 21, 2017

(54) GEAR PUMP FOR A WASTE HEAT RECOVERY SYSTEM

(71) Applicant: Robert Bosch GmbH, Stuttgart (DE)

(72) Inventors: Jakob Branczeisz, Eberdingen (DE); Matthias Riedle, Obersulm (DE)

(21) Appl. No.: 15/458,433

(22) Filed: Mar. 14, 2017

(30) Foreign Application Priority Data
Mar. 15, 2016 (DE) 10 2016 204 199.1

(51) Int. Cl. F04C 2/08; F04C 2/14; F02G 5/02

(52) U.S. Cl. CPC F04C 2/084; F02G 5/02; F04C 2/14; F02G 2280/50; F04C 2240/30

(57) ABSTRACT

A gear pump (1) comprises a pump housing (2), wherein a working chamber (6) is formed in the pump housing (2). A first gearwheel (11) and a second gearwheel (12) are arranged meshing with each other in the working chamber (6). The first gearwheel (11) has a number of first teeth (13) and the second gearwheel (12) has a number of second teeth (14). A first tooth flank (13a, 14a) and a second tooth flank (13b, 14b) are formed on each of the teeth (13, 14). When the gearwheels (11, 12) mesh, the first tooth flanks (13a) of the first teeth (13) are meshed with the first tooth flanks (14a) of the second teeth (14). A coating (15) is arranged on each of the first tooth flanks (13a, 14a). The coating (15) and the first tooth flank (13a, 14a) are positively connected to each other.

### BACKGROUND OF THE INVENTION

The present invention relates to a gear pump, in particular embodied as a feed fluid pump of a waste-heat recovery system of an internal combustion engine.

Fluid delivery pumps are widely known from the prior art, for example in the form of external gear pumps from laid-open application DE 10 2008 042 066 A1. The known gear pump comprises a pump housing, wherein a working chamber is formed in the pump housing. A first gearwheel and a second gearwheel are arranged meshing with each other in the working chamber. The gearwheels have a coating, wherein the coating is applied galvanically or adhesively.

Furthermore, the basic arrangement of feed fluid pumps within a waste-heat recovery system of an internal combustion engine is also known, for example from laid-open application DE 10 2013 205 648 A1. However, how the feed fluid pump can be protected from the aggressive media of waste-heat recovery systems is left open in the known documents.

### SUMMARY OF THE INVENTION

The gear pump according to the invention has a highly wear-proof and media-resistant coating. As a result, said gear pump can in particular very readily be used as a feed fluid pump of a waste-heat recovery system.

For this purpose, the gear pump has a pump housing. A working chamber is formed in the pump housing, wherein a first gearwheel and a second gearwheel are arranged meshing with each other in the working chamber. The first gearwheel has a number of first teeth and the second gearwheel has a number of second teeth. A first tooth flank and a second tooth flank are formed on each of the teeth. When the gearwheels mesh, the first tooth flanks of the first teeth are meshed with the first tooth flanks of the second teeth. A coating is arranged on each of the first tooth flanks. According to the invention, the coating and the first tooth flank are positively connected to each other.

The coating can thus firstly be restricted to the location of contact between the two gearwheels, namely the first tooth flanks of the teeth. Nevertheless, the first tooth flanks are, of course, always meshed with their respective coatings. The contact pressure is therefore advantageously transmitted from one tooth of the one gearwheel to the other tooth of the other gearwheel only via the coatings. Secondly, very large forces can be transmitted by means of the positive connection between the coating and the tooth flanks or teeth. The risk of the coating flaking off is thereby minimized. Damage to or abrasion of the tooth flanks is therefore reduced or entirely prevented. Furthermore, the coating can be selected here in a tribologically such advantageous manner that the hydro-mechanical efficiency of the entire gear pump is improved.

In advantageous developments, a coating is also arranged on each of the second tooth flanks, wherein the coating and the second tooth flank are positively connected to each other. As a result, especially for a reversal of the delivery direction of the gear pump, the second tooth flanks are also designed to be highly media-resistant and wear proof

If, however, the gear pump has only a fixed delivery direction, it may be advantageous because of the manufacturing costs for only the first tooth flanks to have a coating, if the second tooth flanks which are not subjected to a mechanical load have a sufficiently high media resistance even without a coating.

In advantageous embodiments, the coating has a dovetail. The dovetail is anchored in a receiving groove formed in the tooth. A particularly fixed connection between the coating and the tooth or the tooth flank thus arises. High forces can be transmitted.

In an advantageous development, the dovetail is pressed into the receiving groove. The connection between the coating and the tooth or the tooth flank is thereby configured to be free from play. Very high shearing forces can therefore also be transmitted.

In an alternative advantageous development, the coating is sprayed onto the tooth flank and into the receiving groove. This is a particularly suitable manufacturing method. The coating or the dovetail can thus be introduced into the receiving groove in an advantageous manner and free from play. Furthermore, highly complex geometries can therefore be produced cost-effectively.

In advantageous embodiments, the receiving groove runs in the axial direction of the gearwheel. As a result, the receiving groove can be arranged perpendicularly to the pressure loading; the forces can thus be transmitted in the best possible manner from the coating to the basic body, namely the tooth or the gearwheel. When coatings are pressed in, the direction of the pressing-in operations for the individual coatings of all of the teeth is identical, and therefore this manufacturing method is implemented in a particularly advantageous manner.

In advantageous developments, the material of the coating is a plastic, preferably PEEK. Many plastics, in particular PEEK (polyether ether ketone), are highly resistant to aggressive media and at the same time have very good tribological properties. Plastics do not corrode. The service life of the gear pump is thereby increased. Plastics are therefore highly suitable in particular in the use for working media of a waste-heat recovery system.

In alternative advantageous developments, the coating is in the form of a DLC coating, a friction-reducing coating or a ceramic coating. The coating is selected here depending on the field of use. If, for example, high mechanical stresses are present, the DLC coating and the ceramic coating are particularly readily suitable.

In advantageous embodiments, the gear pump is embodied as an external gear pump. The latter can be manufactured highly cost-effectively and have a robust operating performance.

Gear pumps are very readily suitable for use in waste-heat recovery systems of internal combustion engines. The gear pump according to the invention is therefore very advantageously useable in a waste-heat recovery system. The waste-heat recovery system has a circuit conducting a working medium, wherein the circuit comprises a feed fluid pump, an evaporator, an expansion machine and a condenser in the direction of flow of the working medium. The feed fluid pump is embodied here as a gear pump with the above-described features.

In addition to the high chemical resistance, the gear pump has a robust design, cost-effective manufacturing and in addition high protection against wear.

### BRIEF DESCRIPTION OF THE DRAWINGS

Exemplary embodiments of the invention are described in more detail below with reference to the attached drawings, in which:

FIG. 1 shows an external gear pump of the prior art in an exploded illustration, wherein only the important regions are illustrated,

FIG. 2 shows a section through gear pump according to the invention, wherein only the important regions are illustrated,

FIG. 3 shows a gearwheel of a gear pump according to the invention, wherein only the important regions are illustrated,

FIG. 4 shows the detail IV of FIG. 3,

FIG. 5 shows schematically a waste-heat recovery system.

### DETAILED DESCRIPTION

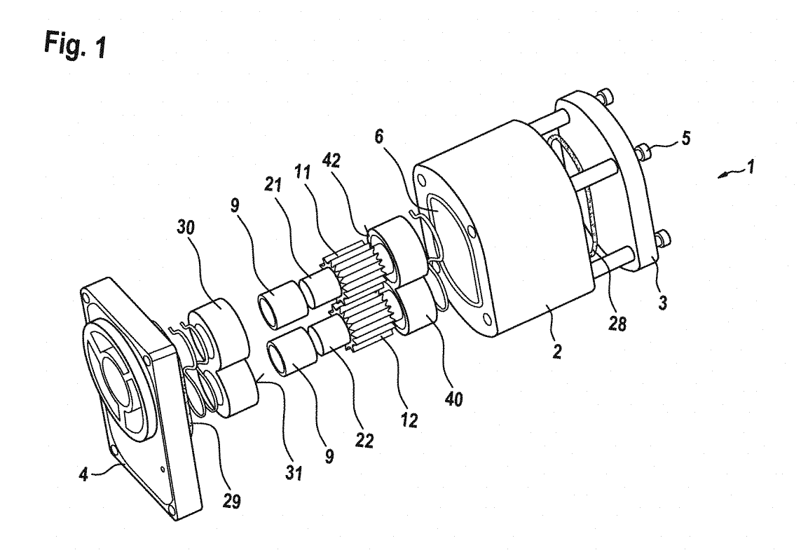

FIG. 1 shows a gear pump 1, which is embodied as an external gear pump, from the prior art in an exploded illustration. The gear pump 1 comprises a pump housing 2, a cover 3 and a bottom flange 4. The cover 3 and the bottom flange 4 are clamped to each other, with the pump housing 2 positioned in between, by means of four screws 5. The pump housing 2, the cover 3 and the bottom flange 4 delimit a working chamber 6.

A first gearwheel 11 and a second gearwheel 12 are arranged meshing with each other in the working chamber 6. The first gearwheel 11 is fastened on a first shaft 21 and the second gearwheel 12 is fastened on a second shaft 22 which is parallel to the first shaft 21. The first shaft 21 serves here as a drive shaft and is connected to a drive (not illustrated), for example a crank shaft of an internal combustion engine. For this purpose, the first shaft 21 protrudes through the bottom flange 4.

The two shafts 21, 22 each protrude through the gearwheel 11, 12 assigned to them and are fixedly connected thereto. The shafts 21, 22 are mounted on both sides of the gearwheels 11, 12. The mounting is undertaken by two double bearing glands 30, 40, wherein the double bearing glands 30, 40 are arranged in the working chamber 6: one double bearing gland 30 is arranged adjacent to the bottom flange 4 and a further double bearing gland 40 is arranged adjacent to the cover 3. Two bearing bushings 9 are pressed into each of the two double bearing glands 30, 40. The bearing bushings 9 of the double bearing gland 30 support the two shafts 21, 22 on the drive side, and the bearing bushings 9 of the further double bearing gland 40 support same on that side of the gearwheels 11, 12 which is opposite thereto.

The four bearing bushings 9 each have a radial bearing function. The axial bearing function is achieved by the two double bearing glands 30, 40: for this purpose, the double bearing gland 30 has a stop surface 31 on the end side, and the further double bearing gland 40 has a further stop surface 42 on the end side. The two stop surfaces 31, 42 interact with the two gearwheels 11, 12. The stop surface 31 supports the two gearwheels 11, 12 in a manner oriented in the axial direction with respect to the bottom flange 4; the further stop surface 42 supports the two gearwheels 11, 12 in a manner oriented in the axial direction with respect to the cover 3.

For the sealing of the working chamber 6 from the environment two seals are arranged on the pump housing 2. One seal 28 is arranged between the pump housing 2 and the cover 3, and a further seal 29 is arranged between the pump housing 2 and the bottom flange 4. The two seals 28, 29 run approximately annularly over the circumference of the pump housing 28, 29 and are customarily arranged in corresponding grooves.

It is known from the prior art that the gearwheels 11, 12 can have an adhesive coating in order to minimize wear. According to the invention, a positive coating is now provided, especially on the meshing tooth flanks of the gearwheels 11, 12. As a result, the gearwheels 11, 12 are designed to be highly wear-resistant even in the case of working media which are poor lubricants, such as, for example, Ethanol.

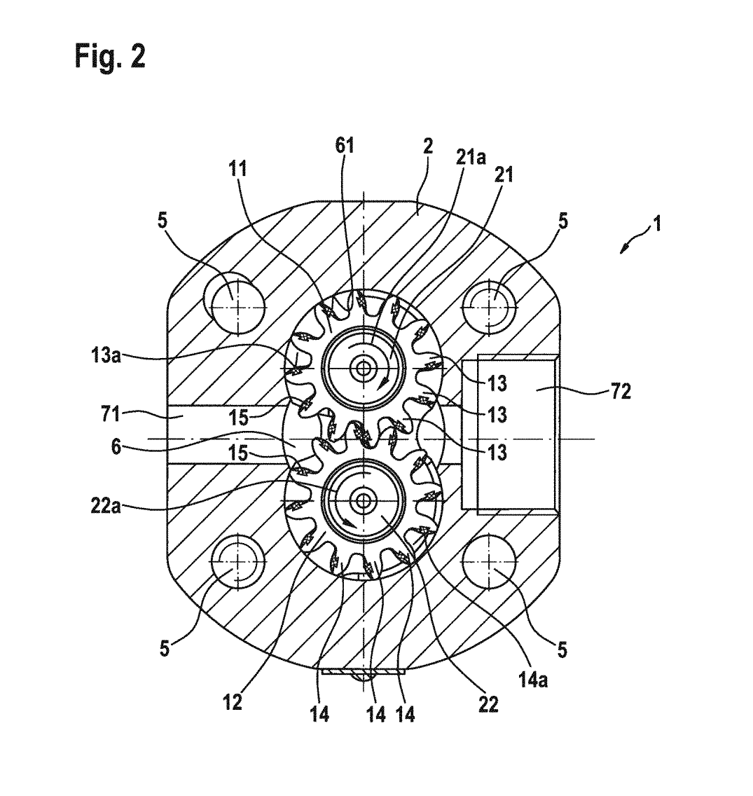

For this purpose FIG. 2 shows a section in the region of the gearwheels 11, 12 through a gear pump 1 according to the invention. The two gearwheels 11, 12 are arranged within the pump housing 2, i.e. in the working chamber 6. In the exemplary embodiment of FIG. 2, the gear pump 1 is designed as an external gear pump; accordingly, the two gearwheels 11, 12 convey the working medium along an inner wall 61 of the pump housing 2.

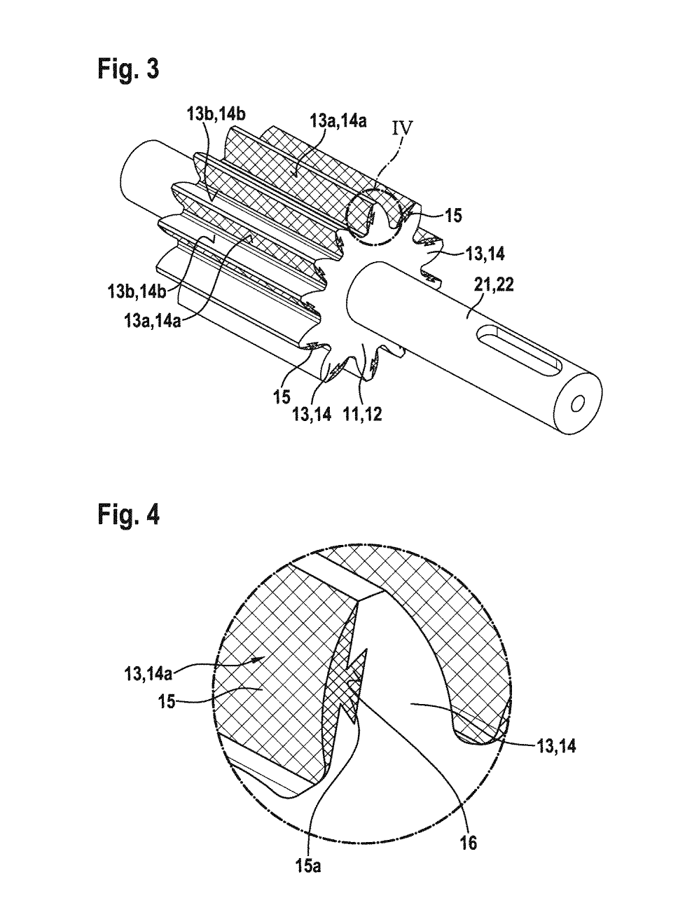

FIG. 2 furthermore shows an inlet channel 71 and an outlet channel 72 of the gear pump 1, said channels leading into the working chamber 6 of the gear pump 1. For this case, the first shaft 21 rotates in the clockwise direction 21a, in the view of FIG. 2, and the second shaft 22 rotates in the anticlockwise direction 22a. Accordingly, the first teeth 13 of the first gearwheel 11 are meshed at their first tooth flanks 13a in each case with the second teeth 14 of the second gearwheel 12 at their first tooth flanks 14a in each case. If, for the operation of the gear pump 1, a reversal of the direction of rotation of the two shafts 21, 22 is not provided—or the reversal takes place only to a small extent or under lower loading—a single-sided coating of the meshing first tooth flanks 13a, 14a is sufficient, as shown in the illustration of FIG. 2. According to the invention, a coating 15 is applied positively here to all of the teeth 13, 14, but only to the meshing first tooth flanks 13a, 14a. An exemplary embodiment of a positive connection between a tooth 13, 14 and a coating 15 is shown below in FIGS. 3 and 4.

In the exemplary embodiment of FIG. 2 the inlet channel 71 and the outlet channel 72 are formed in the pump housing 2. However, in alternative exemplary embodiments, the inlet channel 71 and the outlet channel 72 can also be configured in some other way, for example formed in the cover 3 or in the bottom flange 4. In general, the gear pump 1 according to the invention may also be embodied as an internal gear pump. The pump housing 2 then preferably has a housing bottom since a radial mounting of the gearwheels 11, 12—more precisely the mounting of the outer gear wheel—is then customarily undertaken on the inner wall 61 of the pump housing 2. Accordingly, a pump housing 2 which is open on both sides would not be required.

FIG. 3 shows a gearwheel 11, 12 which is arranged on a shaft 21, 22. The gearwheel 11, 12 here is gearwheel 11, 12 of the gear pump 1 according to the invention. The gearwheel 11, 12 has a number of teeth 13, 14. Of course, the teeth 13, 14 in turn each have two tooth flanks. In the mounted state or during the operation of the gear pump 1, a first tooth flank 13a of the first gearwheel 11 is in each case in contact or meshed with a second gearwheel 12, or with a first tooth flank 14a of the second gearwheel 12, while the second tooth flanks 13b, 14b in each case are not meshed with each other. The positive coating 15 is therefore in each case arranged only on that first tooth flank 13a, 14a of the teeth 13, 14 of the gearwheels 11, 12 which is in contact. It goes without saying that, during the operation, only a small number of teeth 13, 14 are ever meshed at the same time, as illustrated in FIG. 2.

FIG. 4 shows the detail IV from FIG. 3. The positive coating 15 here has a dovetail 15a which forms an undercut, i.e. a positive connection, with the tooth 13, 14. The dovetail 15a is arranged in a receiving groove 16 formed in the tooth 13, 14. The direction of the undercut is approximately the normal direction of the meshing.

The manufacturing or fitting of the coating 15 can be undertaken in different ways here, for example:

in the form of injection molding

by means of a premanufactured coating 15 which is then pushed or pressed in the direction of the shaft 21, 22 into the receiving groove 16.

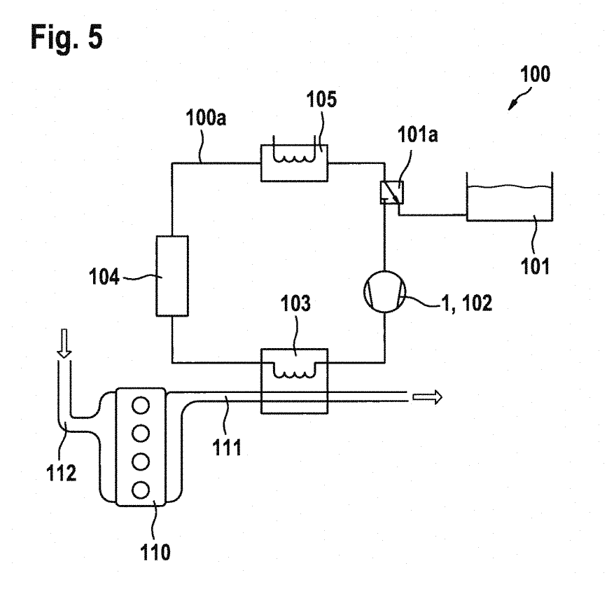

FIG. 5 shows a waste-heat recovery system 100 of an internal combustion engine 110. Oxygen is supplied to the internal combustion engine 110 via an air supply 112; the exhaust gas ejected after the combustion process is removed from the internal combustion engine 110 by an exhaust line 111.

The waste-heat recovery system 100 has a circuit 100a which conducts a working medium and comprises a feed fluid pump 102, an evaporator 103, an expansion machine 104 and a condenser 105 in the direction of flow of the working medium. If required, the working medium can be fed into the circuit 100a from a collecting vessel 101 via a branch line and a valve unit 101a. The collecting vessel 101 may alternatively also be connected here into the circuit 100a.

The evaporator 103 is connected to the exhaust line 111 of the internal combustion engine 110, that is to say utilizes the heat energy of the exhaust gas of the internal combustion engine.

Liquid working medium is conveyed by the feed fluid pump 102, optionally from the collecting vessel 101, into the evaporator 103 and is evaporated there by the heat energy of the exhaust gas of the internal combustion engine 110. The evaporated working medium is subsequently expanded in the expansion machine 104, with mechanical energy being output, for example to a generator (not illustrated) or to a gearing (not illustrated). The working medium is subsequently re-liquefied in the condenser 105 and returned into the collecting vessel 101 or supplied to the feed fluid pump 102.

The manner of operation of the gear pump 1 is as follows:

One of the two gearwheels 11, 12 is driven by the corresponding shaft 21, 22 such that the two gearwheels 11, 12 mesh with each other by the meshing of the corresponding teeth 13, 14. Alternatively, the drive may also be undertaken in some other way, for example electromechanically. In the example of FIG. 2, the gear pump 1 is embodied as an external gear pump; accordingly, the first gearwheel 11 rotates in the clockwise direction 21a and the second gearwheel 12 rotates in the anticlockwise direction 22a. Working medium is thereby conveyed between the gearwheels 11, 12 and the inner wall 61 of the pump housing 2 from the inlet channel 71 into the working chamber 6 and subsequently to the outlet channel 72. the opposite direction of flow seals the meshing of the corresponding teeth 13, 14 between the two gearwheels 11, 12. The working medium is compressed here in the working chamber 6 depending on the pressure being applied to the outlet channel 72.

In addition to the function of conveying the working medium from the inlet channel 71 to the outlet channel 72, the gearwheels 11, 12 or teeth 13, 14, also have the function of transmitting a force via their first tooth flanks 13a, 14a meshing with each other to the corresponding gearwheel 11, 12 meshing therewith. This in principle causes rolling and sliding movements between the first tooth flanks 13a, 14a. So that this operation process with as little wear as possible, lubricant-containing fluids (oils) are customarily used. the adequate viscosity of the adequate lubricating properties of said fluids enable the fluid/working medium used to ideally separate the two meshing tooth flanks 13a, 14a. The working medium therefore prevents or minimizes the abrasive wear.

Since working media, as are used, for example, in waste-heat recovery systems 100, for example Ethanol, have only a very low viscosity and virtually no lubricating property, a lubricating film with sufficient bearing capacity cannot be formed when such critical working media are used. The first tooth flank 13a, 14a—and also the second tooth flank 13b, 14b when the conveying direction is reversed—would therefore permanently operate in the mixed friction range or even with solid-to-solid friction. In addition to an increased friction and the resulting production of heat, this also leads to more rapid wear and therefore to premature failure (breakdown) of the gearwheels 11, 12.

The use of an additional anti-wear layer, namely the coating 15, on the first tooth flanks 13a, 14a which are in each case in contact, enables the attrition, damage to or abrasion of those surfaces of the teeth 13, 14 or of the coating 15 that are important for the operation of the gear pump 1 to be reduced or completely eliminated. The meshing takes place here via the respective coatings 15 of the two meshing teeth 13, 14. As a result, firstly, an entry of particles into the working medium is prevented and, secondly, the operationally reliable functioning of the driving mechanism or of the gear pump 1 is ensured.

As a result, in consequence, the mechanical loss of driving power arising because of the mixed friction in the contact region of the first tooth flanks 13a, 14a is minimized. This makes a positive contribution to improving the hydromechanical efficiency of the gear pump 1. An improved hydromechanical efficiency in turn reduces the friction-reduced entry of heat into the gear pump or into the entire system and therefore improves the energy/heat balance of the system.

According to the invention, the coating 15 is anchored positively in the first tooth flanks 13a, 14a—and optionally also in the second tooth flanks 13b, 14b. This can advantageously be undertaken, for example, via the dovetail 15a of the coating 15, which dovetail is introduced into the receiving groove 16 of the teeth 13, 14. The tooth 13, 14 as basic bodies furthermore serve here as the force-transmitting element and are therefore preferably produced from a metallic basic material. The coating 15 is preferably composed of a friction-reducing material, for example a plastic. Said plastic is then selected in accordance with the intended use of the gear pump 1 and the requirements linked therewith. For example, PEEK is very readily suitable for particularly exacting requirements in respect of media resistance, as is required in waste-heat recovery systems 100.

In advantageous embodiments, the material of the coating 15 should be readily sprayable and optionally subsequently reworkable. The coating 15 is furthermore designed to be resistant to compression. However, the coating 15 does not necessarily have to be resistant to bending or tension since this function is taken on by the support element—the teeth 13, 14.

In alternative advantageous embodiments, the coating 15 may also be in the form of a DLC coating (diamond-like carbon, carbon layer), in the form of a friction-reducing coating, in the form of a coating with ceramic materials or comparable. The surface or coating 15 is selected in accordance with the use sought (thermal expansion, thermal conductivity, permissible surface pressure, processability, costs, etc.).

In a further embodiment of the gear pump 1, both the first tooth flanks 13a, 14a and the second tooth flanks 13b, 14b have a coating 15. In these embodiments, the conveying direction of the gear pump 1 can be reversed during operation without increased wear being obtained. Accordingly, the inlet channel 71 and the outlet channel 72 are then changed depending on the direction of rotation.

According to the invention, the above-described embodiments of the gear pump 1 are very readily suitable for use as a feed fluid pump 102 within the waste-heat recovery system 100 since the working medium used there is highly aggressive and the function of the chemical resistance is very important for the feed fluid pump 102. The chemically resistant and tribologically advantageous material of the coating 15, for example PEEK, protects the gearwheels 11, 12 both against corrosion and wear and thereby extends the service life of the gear pump 1, 102 and of the entire waste-heat recovery system 100.

1. A gear pump (1) comprising a pump housing (2), wherein a working chamber (6) is formed in the pump housing (2), wherein a first gearwheel (11) and a second gearwheel (12) are arranged meshing with each other in the working chamber (6), wherein the first gearwheel (11) has a number of first teeth (13) and the second gearwheel (12) has a number of second teeth (14), wherein a first tooth flank (13a, 14a) and a second tooth flank (13b, 14b) are formed on each of the teeth (13, 14), wherein, when the gearwheels (11, 12) mesh, the first tooth flanks (13a) of the first teeth (13) are meshed with the first tooth flanks (14a) of the second teeth (14), wherein a coating (15) is arranged on each of the first tooth flanks (13a, 14a), and wherein the coating (15) and the first tooth flank (13a, 14a) are positively connected to each other.

2. The gear pump (1) according to claim 1, wherein the coating (15) has a dovetail (15a), wherein the dovetail (15a) is anchored in a receiving groove (16) formed in the associated tooth.

3. The gear pump (1) according to claim 2, wherein the dovetail (15a) is pressed into the receiving groove (16).

4. The gear pump (1) according to claim 2, wherein the coating (15) is sprayed onto the tooth flank (13a, 13b, 14a, 14b) and into the receiving groove (16).

5. The gear pump (1) according to claim 2, wherein the receiving groove (16) runs in the axial direction of the gearwheel (11, 12).

6. The gear pump (1) according to claim 1, wherein a coating (15) is arranged on each of the second tooth flanks (13b, 14b), wherein the coating (15) and the second tooth flank (13b, 14b) are positively connected to each other.

7. The gear pump (1) according to claim 6, wherein the coating on each of the second tooth flanks (15) has a dovetail (15a), wherein the dovetail (15a) is anchored in a receiving groove (16) formed in the associated tooth.

8. The gear pump (1) according to claim 7, wherein the dovetail (15a) is pressed into the receiving groove (16).

9. The gear pump (1) according to claim 7, wherein the coating (15) is sprayed onto the tooth flank (13a, 13b, 14a, 14b) and into the receiving groove (16).

10. The gear pump (1) according to claim 7, wherein the receiving groove (16) runs in the axial direction of the gearwheel (11, 12).

11. The gear pump (1) according to claim 1, wherein the material of the coating (15) is a plastic, preferably PEEK.

12. The gear pump (1) according to claim 1, wherein the coating (15) is in the form of a DLC coating, a friction-reducing coating or a ceramic coating.

13. The gear pump (1) according to claim 1, wherein the gear pump (1) is embodied as an external gear pump.

14. A waste-heat recovery system (100) comprising a circuit (100a) conducting a working medium, wherein the circuit (100a) comprises a feed fluid pump (102), an evaporator (103), an expansion machine (104) and a condenser (105) in the direction of flow of the working medium, wherein the feed fluid pump (102) is embodied as a gear pump (1) according to claim 1.

15. The waste heat recovery system according to claim 14, wherein the coating (15) has a dovetail (15a), wherein the dovetail (15a) is anchored in a receiving groove (16) formed in the associated tooth.

16. The waste heat recovery system according to claim 15, wherein the dovetail (15a) is pressed into the receiving groove (16).

17. The waste heat recovery system according to claim 15, wherein the coating (15) is sprayed onto the tooth flank (13a, 13b, 14a, 14b) and into the receiving groove (16).

18. The waste heat recovery system according to claim 15, wherein the receiving groove (16) runs in the axial direction of the gearwheel (11, 12).

19. The waste heat recovery system according to claim 14, wherein a coating (15) is arranged on each of the second tooth flanks (13b, 14b), wherein the coating (15) and the second tooth flank (13b, 14b) are positively connected to each other.

20. The waste heat recovery system according to claim 19, wherein the coating on each of the second tooth flanks (15) has a dovetail (15a), wherein the dovetail (15a) is anchored in a receiving groove (16) formed in the associated tooth.
